(19) United States
(12) Patent Application Publication
(10) Pub. No.: US 2019/0156694 A1
(43) Pub. Date: May 23, 2019

(54) ACADEMIC LANGUAGE TEACHING MACHINE

(71) Applicants: Edward Manfre, Camarillo, CA (US); Nikolaos Vasiloglou, II, Albuquerque, NM (US)

(72) Inventors: Edward Manfre, Camarillo, CA (US); Nikolaos Vasiloglou, II, Albuquerque, NM (US)

(21) Appl. No.: 16/192,619

(22) Filed: Nov. 15, 2018

Related U.S. Application Data
(60) Provisional application No. 62/588,984, filed on Nov. 21, 2017.

(51) Int. Cl. G09B 7/04; G06N 3/04; G06N 5/04; G09B 19/02; G09B 19/06

(52) U.S. Cl. CPC G09B 7/04; G06N 3/0427; G09B 19/06; G06N 5/043; G09B 19/02; G06N 3/0454

(57) ABSTRACT

A teaching server computer system employs a teaching strategy developed through deep reinforcement learning to teach humans one or more academic languages to fluency. Teaching machine logic is trained in two phases. In a first phase, the teaching machine logic and corresponding student machine logic are trained with supervised training using available recorded lessons of human teachers and human students to provide initial generative models of the teaching logic and the student logic. In the second phase, the initial generative models of the teaching and student logic are combined in virtual lessons in which the teaching logic teaches the student logic in the academic language. The performance of the student logic in learning the academic language is scored and the scores are used to generate rewards in the environment of the deep reinforcement training.

### CROSS REFERENCE TO RELATED APPLICATION

This non-provisional application incorporates and claims priority of U.S. provisional application No. 62/588,984, filed Nov. 21, 2017, which application is incorporated herein in its entirety by this reference.

### FIELD OF THE INVENTION

The present invention relates generally to artificially intelligent computer systems, and, more particularly, to a computer-implemented teaching machine to make human students fluent in an academic language.

### BACKGROUND OF THE INVENTION

Understanding and speaking the terms and phrases used in an academic language (academic language fluency), even at a basic level such as Kindergarten-level math, is essential for learning that subject. Since, currently, all teaching is through language, fluency in an academic language (e.g., mathematics, science, engineering, technology and social studies) is absolutely essential to learning the corresponding academic subject matter.

For example, the most recent international tests (e.g., the Programme for International Student Assessment: OPISA) show about half of participating countries are about the same or worse as the U.S. in math proficiency, where only ⅓ are proficient in math and the remaining ⅔, including the U.S. are not. The 2017 Nation's Report Card shows that two-thirds of eighth graders in the U.S. are not proficient in math. More than half of U.S. students entering 2-year colleges need to take at least one developmental course because they are not ready for college-level math.

These unfortunate statistics stem in large part from a lack of fluency in academic language, in this example, math language. This academic language deficiency tends to begin before children reach school age. As is the case with language in general, not all children are raised with adequate exposure to natural math vocabulary and usage. Too many enter school lacking the verbal understanding they need to learn academic subjects such as math. It is almost impossible to learn a subject if you cannot understand the teacher or the textbook (or any other educational materials, print or digital). Tragically, once students fall behind in Kindergarten or any time after, they tend to fall further behind.

Teaching academic language to children and adults who are behind is no easy task. Such teaching takes time and expertise and involves active use of the language, particularly through purposeful conversation in which feedback and prompts make the most of the conversation. This expertise is found in only a small percentage of parents and professional educators. Thus, only a very small percentage of students are getting the help they sorely need in developing fluency with academic languages.

What is needed is a way to make the expertise of the few experts available to a large portion of the population to teach academic language fluency to enable greater academic achievement.

### SUMMARY OF THE INVENTION

In accordance with the present invention, a teaching server computer system employs a teaching strategy developed through deep reinforcement learning to teach humans one or more academic languages to fluency, for example, (e.g., mathematics, science, engineering, technology and social studies). Ordinary machine learning training techniques are inadequate to train machine logic to expertly teach academic language fluency to human students. Supervised training generally requires many millions of examples to train learning machines to a reliably expert level. However, there simply aren't many millions of recorded academic language lessons for such training and the resources needed to collect such recorded lessons are simply impractical.

Deep reinforcement learning can train learning machines to even surpass human thinking abilities. However, deep reinforcement learning requires human distribution of readily quantifiable rewards at various states in the deep reinforcement learning environment. Here, a human student's fluency in a given academic language is much more nebulous and not easily associated with a state in a lesson environment.

To overcome these limitations, teaching machine logic is trained in two phases. In a first phase, the teaching machine logic and corresponding student machine logic are trained with supervised training using available recorded lessons of human teachers and human students to provide initial generative models of the teaching logic and the student logic. In the second phase, the initial generative models of the teaching and student logic are combined in virtual lessons in which the teaching logic teaches the student logic in the academic language. The performance of the student logic in learning the academic language is scored and the scores are used to generate rewards in the environment of the deep reinforcement training.

The result of this two-stage training is a teaching machine of high expertise trained on available training data. The training machine is scalable and can teach as many students as want to learn.

Note that the various features of the present invention described above may be practiced alone or in combination. These and other features of the present invention will be described in more detail below in the detailed description of the invention and in conjunction with the following figures.

### A BRIEF DESCRIPTION OF THE DRAWINGS

In order that the present invention may be more clearly ascertained, some embodiments will now be described, by way of example, with reference to the accompanying drawings, in which:

FIG. 1 shows an academic language teaching system in which a teaching server teaches human students academic language fluency using a student device in accordance with the present invention;

FIG. 2 is a block diagram of the teaching server of FIG. 1 in greater detail;

FIG. 3 is a block diagram of interactive teaching logic of the teaching server of FIG. 2 in greater detail;

FIG. 4 is a block diagram of teaching machine logic of the teaching server of FIG. 3 in greater detail;

FIG. 5 is a transactional flow diagram of an example lesson dialogue;

FIG. 6 is a state diagram illustrating an atomic quality of a lesson in accordance with an illustrative embodiment of the present invention;

FIG. 7 is a block diagram of teacher training logic of the teaching server of FIG. 3 in greater detail;

FIG. 8 is a logic flow diagram illustrating the training of the teaching server of FIG. 1 in accordance with the present invention; and

FIG. 9 is a block diagram of the teaching server of FIG. 1 in greater detail.

### DETAILED DESCRIPTION OF THE INVENTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

Aspects, features and advantages of exemplary embodiments of the present invention will become better understood with regard to the following description in connection with the accompanying drawing(s). It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute and/or sequential terms, such as, for example, “consist”, “will,” “will not,” “shall,” “shall not,” “must,” “must not,” “only,” “first,” “initially,” “next,” “subsequently,” “before,” “after,” “lastly,” and “finally,” are not meant to limit the scope of the present invention as the embodiments disclosed herein are merely exemplary.

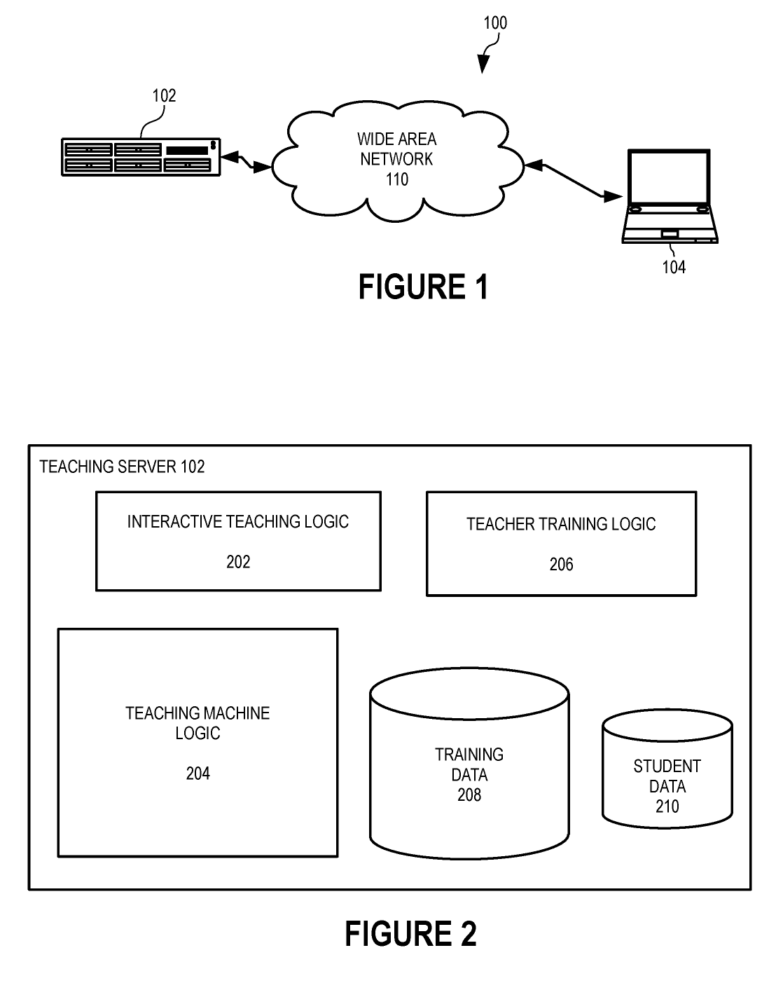

In accordance with the present invention, a server computer system (teaching server 102 FIG. 1), that has a teaching strategy developed through deep reinforcement learning, uses that strategy to teach humans one or more academic languages to fluency. Teaching server 102 is coupled to student device 104 through a wide area network (WAN) 110, which is the Internet in this illustrative embodiment. While a single teaching server 102 is shown, it should be appreciated that the features and behavior of teaching server 102 described herein can be distributed among multiple computers, physical and virtual. In addition, for simplicity and clarity, a single student device 104 is shown. However, it should be appreciated that teaching server 102 can teach numerous students through numerous student devices simultaneously. In fact, a significant advantage of teaching server 102 is this very ability: to scale as needed to serve as many students as need to be taught.

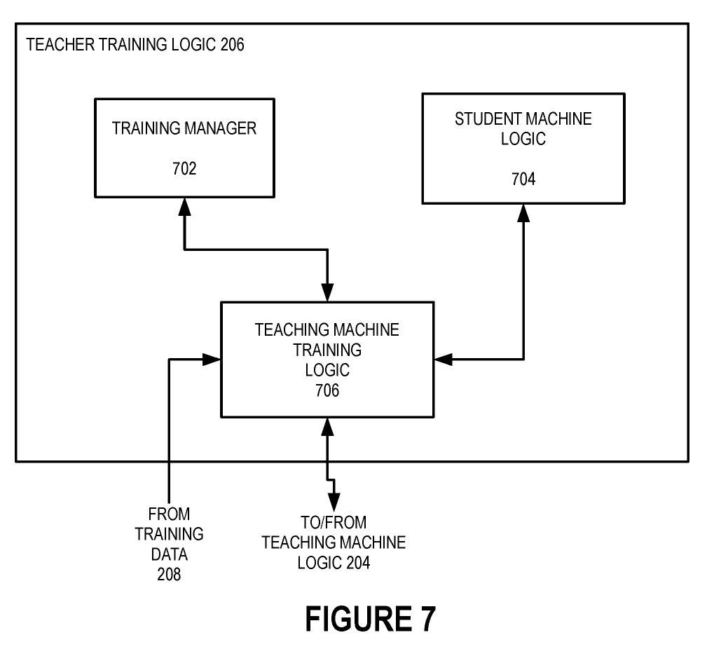

Teaching server 102 is shown in greater detail in FIG. 2 and in even greater detail below in FIG. 7. As shown in FIG. 2, teaching server 102 includes interactive teaching logic 202, teaching machine logic 204, and teacher training logic 206. In addition, teaching server 102 includes training data 208 and student data 210.

Each of the components of teaching server 102 is described more completely below. Briefly, interactive teaching logic 202 conducts an interactive lesson with the subject student to increase fluency of the student in one or more academic languages. The lesson itself is controlled by teaching machine logic 204 in a manner described more completely below. Teacher training logic 206 uses training data 208 to train teaching machine logic 204. Training data 208 includes records representing a large number of live, interactive lessons between various human teachers and various human students. Student data 210 represents the current status and achievements of numerous individual students taught by teaching server 102.

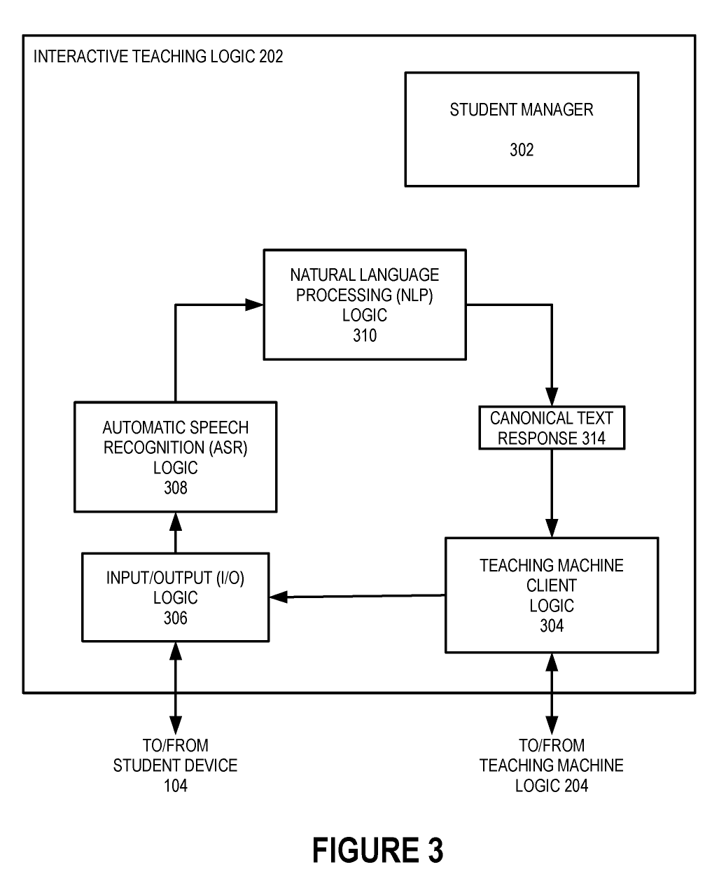

Interactive teaching logic 202 is shown in greater detail in FIG. 3. Student manager 302 manages student data 210, including such things as creation and management of student accounts, student authentication, reports of student performance, etc. Teaching machine client logic 304 serves as a client of teaching machine logic 204 (FIG. 2) through an applications programming interface (API) implemented by teaching machine logic 204. Teaching machine client logic 304 receives from teaching machine logic 204 data representing prompting information to present to the student through student device 104 and sends to teaching machine logic 204 data representing responses from student device 104.

Upon receiving data representing prompting information to present to the student from teaching machine logic 204, teaching machine client logic 304 sends the data to input/output (I/O) logic 306. I/O logic 306 generates an audiovisual signal representing the prompting information and sends the audiovisual signal to student device 104 in a manner that causes student device 104 to present the audiovisual signal to the student. As used herein, an audiovisual signal can include a video signal and/or an audio signal. In alternative embodiments, the prompting information can be something other than an audiovisual signal, e.g., text.

In the interactive lesson with the student, student device 104 captures data representing a response of the student to the prompting information. In this illustrative embodiment, the captured data represents a captured audio signal of the student speaking in response to the prompting information. Student device 104 can include conventional logic that both (i) presents audiovisual signals to the student and (ii), in response, captures an audio signal of the student's oral response. In this illustrative embodiment, this conventional logic is a conventional web browser. I/O logic 306 sends whatever additional conventional logic is needed to present the prompting information and capture the response through the conventional web browser of student device 104.

Upon receipt of the captured response data from student device 104, I/O logic 306 sends the captured response data to automatic speech recognition (ASR) logic 308. ASR logic 308 derives a textual representation of the student's oral response from the captured response data. ASR logic 308 is conventional and known, in this illustrative embodiment, and is not described in greater detail herein. ASR logic 308 sends the textual representation of the student's response to natural language processing (NLP) logic 310.

NLP logic 310 includes known and conventional semantic models for attributing meaning to words and phrases in a natural language. NLP logic 310 produces, from the textual representation of the student's response, canonical text response 314. Canonical text response 314 represents the essence of the student's response in a distilled, simplified, canonical form that teaching machine logic 204 can understand.

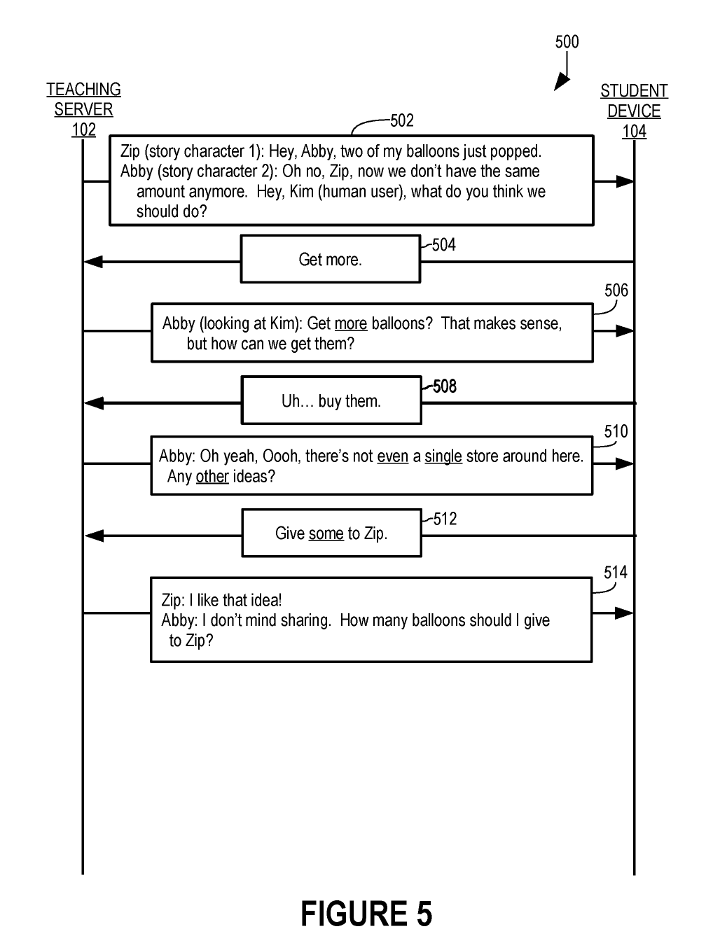

To understand the nature of the simplified, canonical form, it is helpful to consider an example in which one character, Abby, has two (2) more balloons than another character, Zip, has and the student has been asked how they can have the same number of balloons. This illustrative example is represented by dialogue 500 (FIG. 5), which is described more completely below. A correct response could be, “I think, maybe, if Abby could like give Zip just one balloon, maybe that would do it.” Another correct response could be, “give him one of hers” (assuming the gender of the pronouns correctly identified the respective characters). Yet another correct response could be, “Zip can get one from Abby.”

All these responses state essentially the same thing. In the canonical form in this illustrative embodiment, the response would be characterized as a transfer with three parameters: (i) from whom, (ii) to whom, and (iii) a quantity, each of which can be represented as unknown. In addition to transfers, canonical forms can be created for other types of responses the student can be expected to make, e.g., relationships between two values (less than, greater than, etc.), differences, sums, etc.

Teaching machine client logic 304 receives canonical text response 314 from NLP logic 310 and sends canonical text response 314 to teaching machine logic 204 to inform teaching machine logic 204 of the student's response.

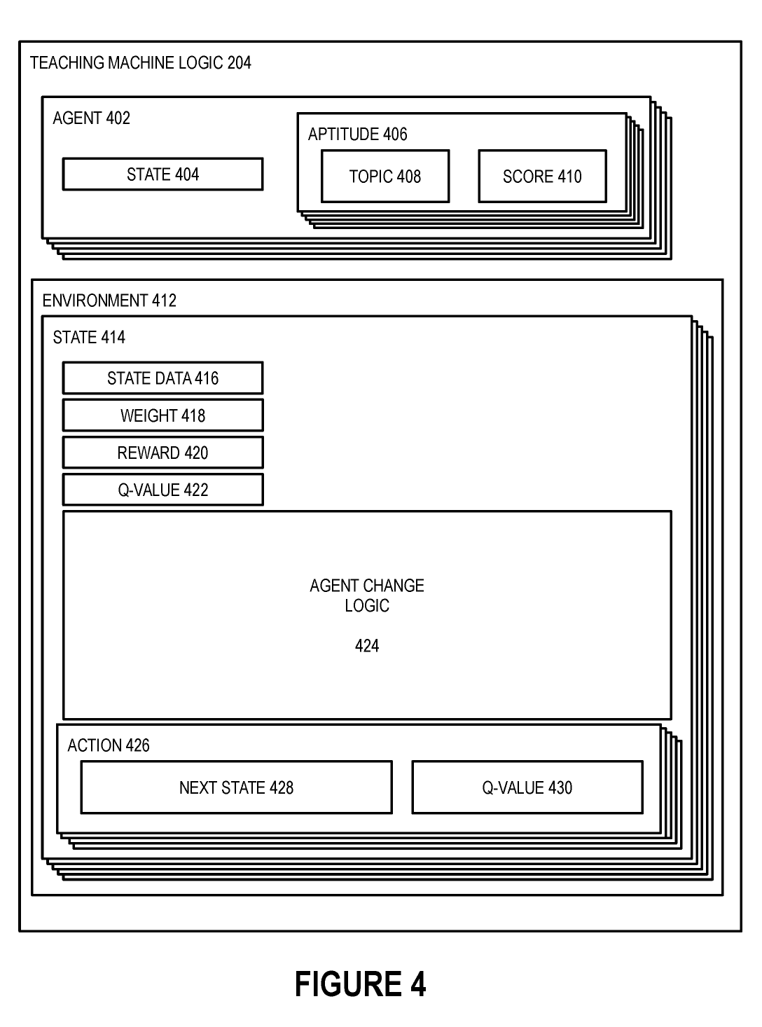

Teaching machine logic 204 is shown in greater detail in FIG. 4. In this illustrative embodiment, teaching machine logic 204 is a deep reinforcement learning machine and includes a sequence-to-sequence recurrent neural network (RNN) architecture. The RNN architecture can be any of a number of known RNN architectures, including, for example, a Long Short Term Memory (LSTM), a Gated RNN, and a neural Turing Machine.

Teaching machine logic 204 includes data representing a number of agents 402, each of which represents a current state of a corresponding human student. State 404 identifies the current one of states 414 of environment 412, described below, of the subject student. Agent 402 also represents various aptitudes of the subject student as an aptitude matrix that includes a number of aptitudes 406. Each of aptitudes 406 includes a topic 408 and a corresponding score 410. Topic 408 includes data representing a given topic of a number of topics in which the student is to become proficient. Score 410 includes data representing the proficiency of the student in topic 408.

Topic 408 is one of a number of topics that, in this illustrative embodiment, are hierarchical and are manually configured. For example, a top level topic can represent the particular academic language in which the student is to become proficient, e.g., mathematics. A sub-topic of mathematics can be relationships such as more, less, and the same (equal). The full compliment of topics is determined by human experts of academic language fluency. The following Table provides illustrative examples of words and phrases in illustrative examples of topics.

TABLE A

| Topic | Words, Phrases |
|---|---|
| Inequality | more, less, fewer, more than, less than, fewer than, a lot more than, a lot less |
| (number or | than |
| amount) | some more, a little more (than), a little less (than) |
| | more than [specific number] |
| | fewer than [specific number] |
| Amount/ | a lot, lots, a large amount, many |
| Number | a little, a small amount, a small number |
| | some, none, all |
| | there are [number] [object] and [number] [other object] |
| | [number] of the [objects] are [attribute] |
| Subset | each, each one, every one, each of, both, both of, another |
| | a number of, a few of, some of |
| | the rest, all the rest, most of just, only, every |
| Equality | same, same as, just as many as, same number (of), same amount (of) |
| (number or | equal, equal number of, equal amount of |
| amount) | about the same (as), about the same number (of), about as many (as) |
| | about the same amount (as), about as much(as), |
| | exactly the same (as) |
| | fair |
| Equality | same length (as), same height (as), same size (as) |
| (size) | just as long (as), just as tall (as), just as short (as) |
| | about as long (as), about as tall (as), about as big (as) |
| | about as short (as), about as small (as), about as little (as) |
| | equal length, equal height, equal size |
| | about the same length (as), about the same height (as), about the same size |
| | (as) |
| inequality | bigger (than), a lot bigger (than), a little bigger (than) |
| (size) | smaller (than), a lot smaller (than), a little smaller (than) |
| | longer (than), a lot longer (than), a little longer (than) |
| | taller (than), a lot taller (than), a little taller (than) |
| | shorter (than), a lot shorter (than), a little shorter (than) |
| Half | halfway, half of the way, one-half of, halfway between, halfway around |
| (linear) | more than halfway, less than halfway, about halfway |
| | a little more than halfway, a little less than halfway, almost halfway |
| Half | half full, half of the, one-half full |
| (fullness) | a little more than half full, a little less than half full, almost half full |
| | half empty |
| Half | the [object[ is half [color], the [object] is one-half [color], half of the [object] |
| (has attribute) | is [color] |
| | more than half [color], less than half [color] |
| First and Last | first, second, first in line, second in line, first to do (something), first one, |
| | first two |
| | last, last in line, last to do (something), last one, last two |
| | last long, last a long time |
| Relative | outside, inside |
| position | behind, in front of, ahead of |
| | above, below, on top of, under, underneath |
| | close to, next (to), next in line, beside, near, beside closer (to), nearer (to), |
| | farther (from) |
| | left side, on the left (of), to the left (of) |
| | right side, on the right (of), to the right (of) |
| Quantitative | 1 more than, more than 1 |
| comparison | 2 more than, more than 2 |
| | more than (number) |
| | less than (number), fewer than (number) |

Returning to FIG. 4, score 410 represents the degree of fluency of the student with the associated topic 408. In this illustrative embodiment, score 410 ranges from 0.0 for not at all fluent in topic 408 to 1.0 for perfectly fluent in topic 408.

Environment 412 includes a number of states 414, which collectively represent the neurons of the RNN of teaching machine logic 204. Each state, e.g., state 414, includes state data 416, a weight 418, a reward 420, a Q-value 422, agent change logic 424, and a number of actions 426 that can be taken to move an agent to a next one of states 414.

To provide an illustrative context in which to describe the behavior of teaching server 102 and teaching machine logic 204, a dialogue diagram 500 (FIG. 5) represents an example teaching dialogue between teaching server 102 and a student using student device 104. To start this illustrative lesson, teaching server 102 causes student device 104 to present a brief story to provide a lesson context. In this illustrative example, two characters, Abby and Zip, each have a number of balloons, initially, the same number of balloons.

State data 416 represents a state of the current lesson, while state 414 represents a state within environment. For example, state data 416 can identify the particular educational narrative, whether an introduction to the narrative has been presented to the student, and the number of balloons possessed by each of Zip and Abby.

Agent change logic 424 defines the behavior of teaching machine logic 204 in state 414. In this illustrative example, agent change logic 424 (i) causes I/O logic 306 to present to the student the prompt of Zip saying, in step 502 (FIG. 5), “Hey, Abby, two of my balloons just popped.” and Abby responding, “Oh no, Zip, now we don't have the same amount anymore. Hey, Kim, what do you think we should do?”; (ii) decreases the number of balloons held by Zip by two within state data 416 (FIG. 4); and (iii) awaits data representing Kim's (the student's) response from interactive teaching logic 202.

Agent change logic 424 processes the student's response from interactive teaching logic 202 and also processes aptitudes 406 of the student as neuron input. At least in part, agent change logic 424 uses the student's response, i.e., canonical text response 314 (FIG. 3), to adjust aptitudes 406 (FIG. 4) of the student and to select one of actions 426 as the next action to take.

There are a number of ways in which agent change logic 424 can adjust aptitudes 406. In this illustrative embodiment, score 410 represents a running average of accuracy of a number (e.g., 5) of responses of the student with a value of 1.0 for a correct response and 0.0 for an incorrect response. Thus, a score 410 of 1.0 represents that the student has been correct within topic 408 for five (5) consecutive times.

Each of actions 426 represents a next state 428, that identifies one of states 414 of environment 412 to transition to, and a Q-value 430 associated with that state. Agent change logic 424 chooses the one of actions 426 with the greatest Q-value 430 as the next state for the agent 402 representing the student.

Agent logic 424 uses weight 418 in adjusting aptitudes 406 of the student. Weight 424 is determined by training teaching machine logic 204 in a manner described below. Reward 420 is manually assigned to state 414 for use in deep reinforcement learning and is used to calculate Q-value 422. Reward 420 and Q-value 422 are also used in training teaching machine logic 204.

In some embodiments, individual lessons, e.g., the lesson beginning with the dialogue of steps 502-514 (FIG. 5), are atomic, meaning that each lesson is completed before states 414 (FIG. 4) of another lesson are entered. In one embodiment, each lesson is implemented as an individual teaching machine that is itself a state within the entirety of environment 412. In an alternative embodiment, lessons are made atomic by manual configuration of actions 426. In particular, actions 426 only allow state transitions to others of states 414 of the same lesson until a state in which the student has successfully completed the lesson is reached.

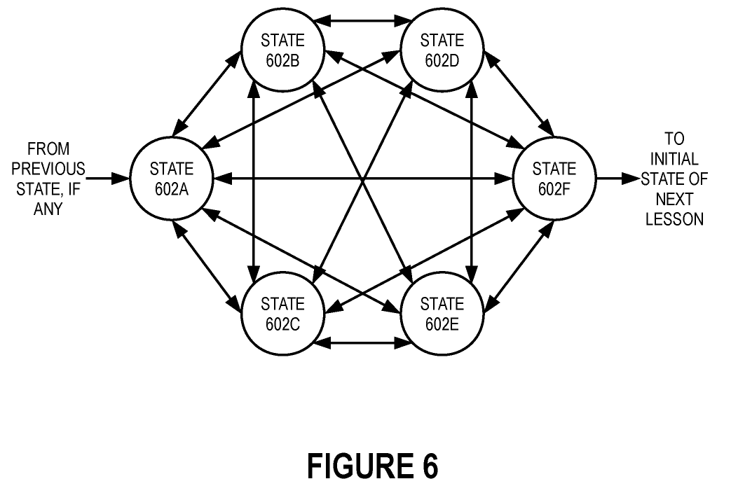

States 602A-F are illustrative of this manual enforcement of atomic lessons. State 602A-F are states of a single, atomic lesson. State 602A represents the initial state of the lesson. From state 602A, any of states 602A-F can be the next state according to actions 426 (FIG. 4) but not any state of any other lesson. The same is true of states 602B-E. The particular path through states 602A-F (FIG. 6) is determined by training of the teaching machine. Once the student has completed the lesson of states 602A-F, state 602F is reached and teaching machine logic 204 can progress to an initial state of another lesson.

As described above, teacher training logic 206 uses training data 208 to train teacher machine logic 204. Teacher training logic 206 is shown in greater detail in FIG. 7.

Training manager 702 includes a user interface through which training of teaching machine logic 204 can be controlled. Human engineers use training manager 702 to manage labels used by teaching machine training logic 706 in supervised training and to configure rewards 420 (FIG. 4) distributed throughout environment 412 for deep reinforcement training.

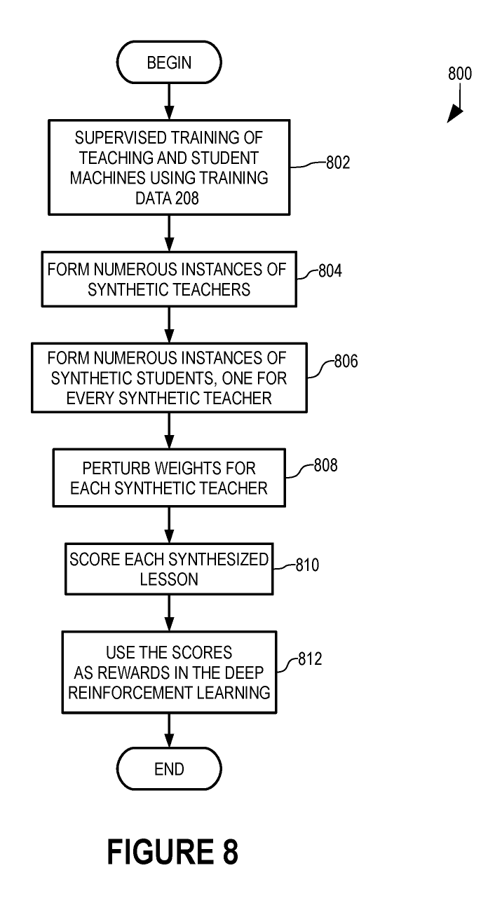

Training of teacher machine logic 204 by teacher training logic 206 is illustrated by logic flow diagram 800 (FIG. 8). In step 802, teaching machine training logic 706 uses training data 208 (FIG. 2) to create an initial generative model within teaching machine logic 204 and student machine logic 704 (FIG. 7).

Training data 208 (FIG. 2) includes textual transcripts of numerous lessons taught by human teachers to human students. An audio signal of such lessons are processed by ASR logic 308 (FIG. 3) and, in some embodiments, NLP logic 310 to produce textual transcripts from the recorded audio signal. The training by teacher training logic 206 in step 802 (FIG. 8) is controlled by human engineers through training manager 702 (FIG. 7) to manage labels used by teaching machine logic 204 and student machine logic 704 and to generally supervise this training.

In this illustrative embodiment of step 802, teacher training logic 206 trains teaching machine logic 204 and student machine logic 704 by applying sequences of training data 208, each of which comprises a teacher's utterance and a corresponding, responsive student utterance, to a gradient descent trainer.

The result is the initial generative model within teaching machine logic 204 and student machine logic 704 (FIG. 7). Given this initial generative model, teaching machine logic 204 can interact with student machine logic 704 to carry out synthetic dialogues in which teaching machine logic 204 teaches student machine logic 704 the academic material of training data 208.

This initial generative model may be inadequate for teaching machine logic 204 to teach human students particularly well or efficiently. Such could be the case if training data 208 is not a particularly extensive collection of recorded lessons, e.g., millions of lessons. To remedy this, a second phase of training of teaching machine logic 208 applies deep reinforcement learning by forming numerous instances of a synthetic teacher from teaching machine logic 204 in step 804 and forming numerous corresponding instances of a synthetic student from student machine logic 704, which is an LSTM RNN in this illustrative embodiment, in step 806.

In step 808, teaching machine training logic 706 perturbs parameters of each instance of teaching machine logic 204, e.g., weights 418 (FIG. 4), to provide variation in the teaching approaches employed by each instance.

In step 810, teaching machine training logic 706 scores the performance of each corresponding instance of student machine logic 704 from each synthetic lesson. In step 812, teaching machine training logic 706 uses the scores from step 810 as rewards, e.g., reward 420, to guide the various instances of teaching machine logic 204 to provide ever improving education to student machine logic 704.

Teaching machine training logic 706 repeats steps 808-812 numerous times until successive iterations fails to provide measurably significant improvements.

After training according to logic flow diagram 800, teaching machine logic 204 represents high expertise in the teaching of an academic language and can be easily and inexpensively scaled to teach as many human students as need such instruction.

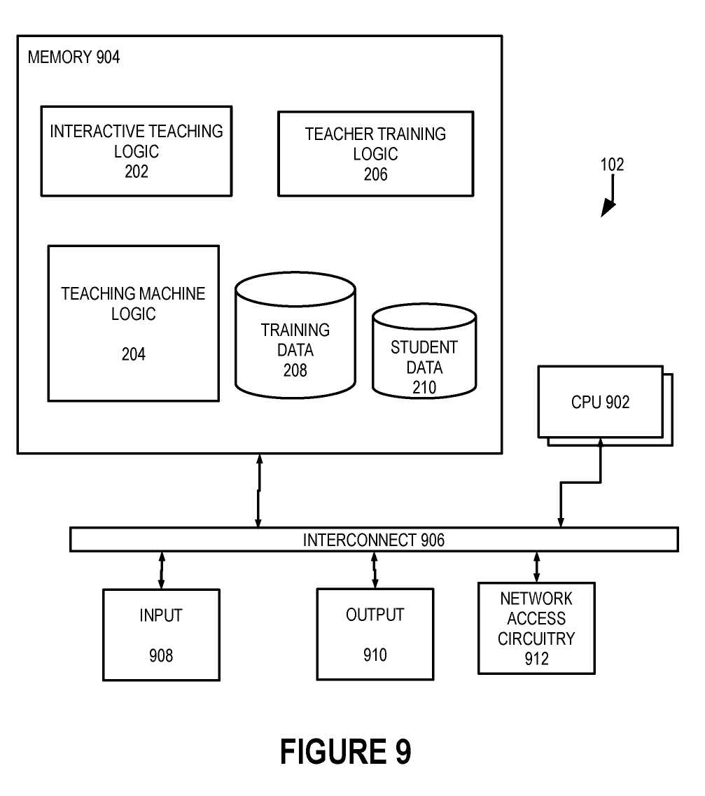

Teaching server 102 is shown in greater detail in FIG. 9. As noted above, it should be appreciated that the behavior of teaching server 102 described herein can be distributed across multiple computer systems using conventional distributed processing techniques. Teaching server 102 includes one or more microprocessors 902 (collectively referred to as CPU 902) that retrieve data and/or instructions from memory 904 and execute retrieved instructions in a conventional manner. Memory 904 can include generally any computer-readable medium including, for example, persistent memory such as magnetic and/or optical disks, ROM, and PROM and volatile memory such as RAM.

CPU 902 and memory 904 are connected to one another through a conventional interconnect 906, which is a bus in this illustrative embodiment and which connects CPU 902 and memory 904 to one or more input devices 908, output devices 910, and network access circuitry 912. Input devices 908 can include, for example, a keyboard, a keypad, a touch-sensitive screen, a mouse, a microphone, and one or more cameras. Output devices 910 can include, for example, a display—such as a liquid crystal display (LCD)—and one or more loudspeakers. Network access circuitry 912 sends and receives data through computer networks such as WAN 110 (FIG. 1). Server computer systems often exclude input and output devices, relying instead on human user interaction through network access circuitry. Accordingly, in some embodiments, teaching server 102 does not include input devices 908 and output devices 910.

A number of components of teaching server 102 are stored in memory 904. In particular, interactive teaching logic 202, teaching machine logic 204, and teacher training logic 206 are each all or part of one or more computer processes executing within CPU 902 from memory 904 As used herein, “logic” refers to (i) logic implemented as computer instructions and/or data within one or more computer processes and/or (ii) logic implemented in electronic circuitry.

Training data 208 and student data 210 are each data stored persistently in memory 904 and can be implemented as all or part of one or more databases.

It should be appreciated that the distinction between servers and clients is largely an arbitrary one to facilitate human understanding of purpose of a given computer. As used herein, “server” and “client” are primarily labels to assist human categorization and understanding.

The above description is illustrative only and is not limiting. The present invention is defined solely by the claims which follow and their full range of equivalents. It is intended that the following appended claims be interpreted as including all such alterations, modifications, permutations, and substitute equivalents as fall within the true spirit and scope of the present invention.

What is claimed is:

1. A method for providing a teaching machine that is capable of teaching human students fluency in an academic language, the method comprising:
training machine logic using records of lessons in the academic language given by one or more human teachers to one or more human students to form both (i) virtual teacher logic and (ii) virtual student logic;
applying deep reinforcement training to the virtual teacher logic by at least:
forming a deep reinforcement training environment that includes multiple states, each of which includes a reward;
causing the virtual teacher logic to conduct virtual lessons in the academic language with the virtual student logic within the deep reinforcement training environment;
scoring performance of the virtual student logic in each of the lessons; and
setting the rewards of the states of the deep reinforcement training environment according to scored performance; and
configuring the virtual teacher logic after the deep reinforcement training to teach the academic language to human students.

2. The method of claim 1 wherein the virtual teacher logic comprises a sequence-to-sequence recurrent neural network architecture.

3. The method of claim 1 wherein the virtual teacher logic comprises a long short term memory recurrent neural network architecture.

4. The method of claim 1 wherein the virtual teacher logic comprises a gated recurrent neural network architecture.

5. The method of claim 1 wherein the virtual teacher logic comprises a neural Turing machine architecture.

6. The method of claim 1 wherein the virtual student logic comprises a sequence-to-sequence recurrent neural network architecture.

7. The method of claim 1 wherein the virtual student logic comprises a long short term memory recurrent neural network architecture.

8. A teaching machine computer system resulting from performance of the steps of claim 1.
